(19) United States
(12) Patent Application Publication
(10) Pub. No.: US 2006/0146224 A1
(43) Pub. Date: Jul. 6, 2006

(54) Flat display apparatus

(75) Inventors: Byung Chul Lee, Chungcheongnam-do (KR); Bog ryong Kim, Gyeongsangbuk-do (KR); Tae soo Hwang, Gyeongsangbuk-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/313,934

(22) Filed: Dec. 22, 2005

(30) Foreign Application Priority Data
Feb. 23, 2005 (KR) 10-2005-0014966
Feb. 23, 2005 (KR) 10-2005-0014967
Dec. 23, 2004 (KR) 10-2004-0111122

(51) Int. Cl. G02F 1/1333

(52) U.S. Cl. 349/58

(57) ABSTRACT

The present invention relates to a flat display apparatus, and more particularly, the present invention relates to a flat display apparatus which can prevent a misdischarge and enhance productivity. The flat display apparatus according to the present invention includes a display panel, a frame provided on a rear surface of the display panel, and at least two thermal conductive sheets placed between the display panel and the frame. The thermal conductive sheets are spaced apart from each other at certain intervals. According to the present invention, by improving the structure of the flat display apparatus, the workability can be enhanced and a temperature gradient of the flat display panel can be suppressed.

This nonprovisional application claims priority under 35 U.S.C. § 119(a) on Patent Application Nos. 10-2004-0111122 and 10-2005-0014966 and 10-2005-0014967 filed in Korea on December 23, and Feb. 23, 2005, the entire contents of which are hereby incorporated by reference.

### BACKGROUND OF THE INVENTION

1. Field of the Invention

The present invention relates to a flat display apparatus, and more particularly, the present invention relates to a flat display apparatus which can prevent a misdischarge and enhance the productivity.

2. Description of the Background Art

In general, there are the various kinds of flat display apparatuses such as the liquid crystal display (LCD), the field emission display (FED), the organic electroluminescence display, the plasma display and the like. Particularly, the plasma display is a device in which, when an inert gas located between a soda-lime glass front substrate and a rear substrate is discharged by a high-frequency voltage, vacuum ultraviolet rays are generated, so that a fluorescent substance or phosphor coated therein emits light to display the image.

FIG. 1 is a view showing schematically a structure of a background art plasma display apparatus. As shown in FIG. 1, the plasma display comprises a case 110 including a front cabinet 111 and a back cover 112; a plasma display panel 120 for exciting the fluorescent substance; a driving unit 130 including a printed circuit board for driving and controlling the plasma display panel; a frame 140 connected to the driving unit for radiating heat generated when the plasma display apparatus is operated and for supporting the plasma display panel; and a thermal conductive sheet 150 formed between the plasma display panel and the frame for transmitting heat generated at the plasma display panel to the frame.

The plasma display also includes a filter 160 formed by adhering a film on a transparent glass substrate and provided at a front side of the plasma display panel at a predetermined interval; a finger spring gasket 170 supporting the filter and electrically connecting the metal back cover and the filter; and a module supporter 190 supporting the plasma display apparatus including a filter supporter 180 and a driving apparatus.

A structure of the background art plasma display panel is described in detail with reference to FIG. 2. In the plasma display panel, a front substrate 200 and a rear substrate 210 are combined in parallel with each other at a predetermined interval. The front substrate is formed by arranging a plurality of sustain electrode pairs, each of which includes a scan electrode 202 and a sustain electrode 203, on a front glass 201 which is a display surface on which the image is displayed. The rear substrate 210 is formed by arranging a plurality of address electrodes 213 on a rear glass 211 acting as a rear surface. The address electrodes 213 and the plurality of sustain electrode pairs 202, 203 cross each other.

In the front substrate 200, the scan electrode 202 and the sustain electrode 203 each comprise a pair of electrodes. Each of the pair of electrodes comprises a transparent electrode (a) made of transparent ITO (indium tin oxide) and a bus electrode (b) made of a metal. The scan electrode 202 and the sustain electrode 203 limit the discharge current and are covered with one or more upper dielectric layers 204 which insulate the electrode pair. A protective layer 205 on which magnesium oxide (MgO) is deposited is formed on an upper surface of the dielectric layer 204 for easily discharging.

In the rear substrate 210, stripe type (or well type) walls 212 are disposed parallel with each other for forming a plurality of discharge spaces (that is, a plurality of discharge cells). Also, a plurality address electrodes 213 which perform the address discharge to generate vacuum ultraviolet rays are disposed parallel with the walls 212. An upper surface of the rear substrate 210 is coated with red, green and blue (R,G,B) fluorescent substances 214 emitting visible rays for displaying an image when the address discharge is generated. A lower dielectric layer 215 is formed between the address electrodes 213 and the fluorescent substances 214 for protecting the address electrodes 213.

A thermal conductive sheet is formed on a rear surface of the plasma display panel for transmitting heat generated from the plasma display panel, as shown in FIG. 3. The background art thermal conductive sheet 310 is formed on a frame 320, and then is adhered to a plasma display panel 330 having a front substrate 331 and a rear sheet 332. The thermal conductive sheet 310 makes the frame 320 adhere to the plasma display panel 330, and transmits the generated heat toward the frame 320 when the plasma display panel 330 is operated. Also, the frame 320 is adhered to the plasma display panel 330 by the thermal conductive sheet 310 to support the thermal conductive sheet 310 and radiate heat transmitted through the thermal conductive sheet 310 toward the outside.

The background art thermal conductive sheet is formed with the single sheet, and there is a drawback that the workability becomes lower. That is, when the frame is adhered to the plasma display panel by the single thermal conductive sheet, due to a large surface area of the thermal conductive sheet, an adhesive density between the thermal conductive sheet and the plasma display panel is reduced to lower the workability. If the adhesive density between the thermal conductive sheet and the plasma display panel is reduced as described above, an air layer is partially formed between the thermal conductive sheet and the plasma display panel. Such an air layer reduces the thermal conductivity, and therefore heat generated when the plasma display panel is operated cannot be radiated effectively.

### SUMMARY OF THE INVENTION

Accordingly, an object of the present invention is to solve at least the problems and disadvantages of the background art.

An object of the present invention is to provide a flat display apparatus which has an improved structure to enhance the workability.

Another object of the present invention is to provide a flat display apparatus which reduces the manufacturing cost.

Yet another object of the present invention is to provide a flat display apparatus which can suppress a temperature gradient of the flat display panel.

A flat display apparatus according to the present invention comprises a display panel; a frame provided at a rear surface of the display panel; and at least two thermal conductive sheets located between the display panel and the frame, the thermal conductive sheets being side-by-side and spaced apart from each other.

Another flat display apparatus according to the present invention comprises a display panel; a frame provided at a rear surface of the display panel; and at least two thermal conductive porous sheets located between the display panel and the frame, the thermal conductive porous sheets being side-by-side and spaced apart from each other, wherein an interval between the thermal conductive porous sheets is 0.1 mm to 5.0 mm.

Yet another flat display apparatus according to the present invention comprises a display panel; a frame provided at a rear surface of the display panel, a first region of the frame having one or more holes therein; and a thermal conductive sheet located between the display panel and the frame, wherein the thermal conductive sheet is located at the first region of the frame.

The present invention is advantageous in that the workability can be enhanced by improving a structure of the flat display apparatus. Also, the present invention is advantageous in that the manufacturing cost can be reduced by improving a structure of the flat display apparatus. In addition, the present invention is advantageous in that a temperature gradient of the flat display panel can be suppressed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and with reference to the accompanying drawings in which like numerals refer to like elements, which are given by way of illustration only, and thus, are not limitive of the present invention.

FIG. 1 is a view showing schematically a structure of the background art plasma display apparatus

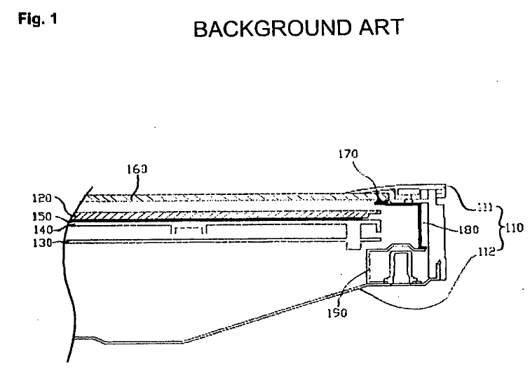

FIG. 2 is a view showing the background art plasma display apparatus.

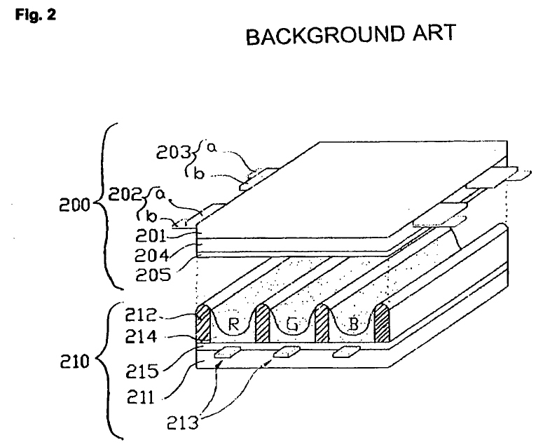

FIG. 3 is a view showing schematically a thermal conductive sheet in the background art plasma display apparatus.

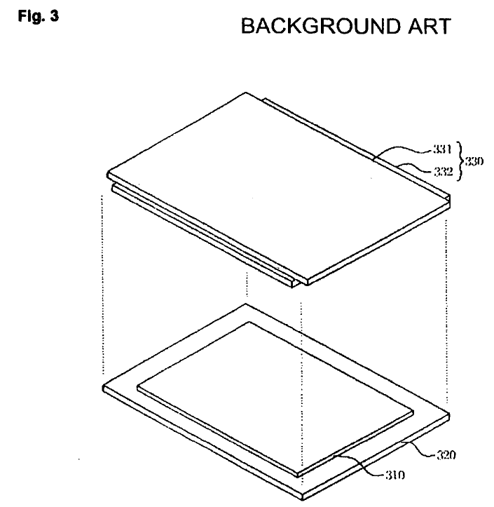

FIG. 4 is a view showing schematically a thermal conductive sheet in a plasma display apparatus according to the first embodiment of the present invention.

FIG. 5 is a view showing schematically a modified structure of the flat display apparatus according to the first embodiment of the present invention.

FIG. 6 is a view showing schematically a frame according to the first embodiment of the present invention.

FIG. 7 is a view showing schematically another modified structure of the flat display apparatus according to the first embodiment of the present invention.

FIG. 8a and FIG. 8b are views for illustrating a structure of the flat display apparatus according to the second embodiment of the present invention.

FIG. 9a and FIG. 9b are graphs for illustrating the thermal characteristic of the flat display panel according to the second embodiment of the present invention.

### DETAILED DESCRIPTION OF DISCLOSED EMBODIMENTS

Embodiments of the present invention will be described in more detail with reference to the drawings.

A flat display apparatus according to the present invention includes a display panel, a frame provided on a rear surface of the display panel, and at least two thermal conductive sheets formed between the display panel and the frame. The thermal conductive sheets are spaced apart from each other at predetermined intervals.

The thermal conductive sheets are smaller in size than the display panel, so that edges of the thermal conductive sheets are spaced from an edge of the display panel. In one embodiment, the interval between the thermal conductive sheets is 0.1 mm to 5.0 mm. Also, in one embodiment, the thermal conductive sheets have a thickness of 0.1 mm to 2.0 mm.

The thermal conductive sheets are arranged in a longitudinal direction or a widthwise direction of the frame. In one embodiment, the thermal conductive sheet is a porous pad or porous sheet. The porous sheet may contain a foaming agent, such as urethane foam. The porous pad or the porous sheet silicon material. The frame, the thermal conductive sheets and the frame have one or more holes formed thereon.

Another flat display apparatus according to the present invention includes a display panel, a frame provided on a rear surface of the display panel, and two or more thermal conductive sheets placed between the display panel and the frame. In one embodiment, the thermal conductive sheets are spaced apart from each other at an interval of approximately 0.1 mm to 5.0 mm.

Yet another flat display apparatus according to the present invention includes a display panel, a frame provided on a rear surface of the display panel, and a thermal conductive sheet formed between the display panel and the frame. In one embodiment, the frame has one or more holes formed thereon.

The thermal conductive sheet may be a porous pad or a porous sheet containing a foam agent. The holes may be disposed regularly or irregularly on the frame. In one embodiment, each hole formed on the frame has a size of approximately 0.1 mm to 10.0 mm. The holes are formed on a section of the frame on which the thermal conductive sheet is placed. The thermal conductive sheet has one or more holes formed thereon, having a diameter of approximately 0.1 mm to 5.0 mm. The holes formed on the thermal conductive sheet correspond to the holes formed on the frame.

Hereinafter, a first embodiment according to the present invention is described with referenced to accompanying drawings.

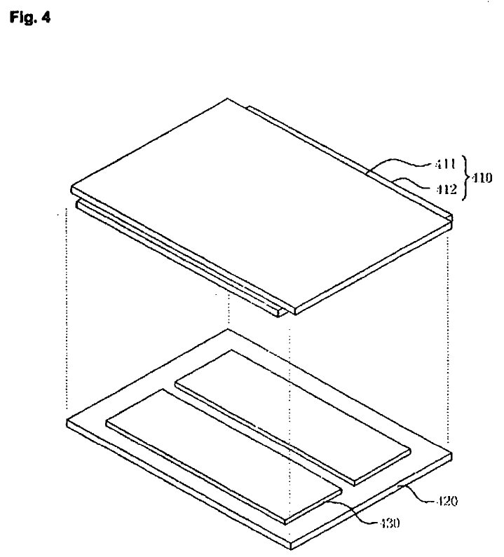

FIG. 4 is a view schematically showing a thermal conductive sheet in a plasma display apparatus according to the first embodiment of the present invention. As shown in FIG. 4, a thermal conductive sheet 430 of the flat display apparatus is formed on a frame 420, and then adhered to a rear surface of a flat display panel 410.

The flat display panel 410 includes a front substrate 411 of a flat display apparatus such as a PDP, an LCD and the like, and a rear substrate 412. An image is displayed on the flat display panel 410 when the flat display apparatus is operated. The frame 420 supports the flat display panel 410 and radiates heat generated by the flat display panel 410 toward an outside when the apparatus is operated.

One surface of the thermal conductive sheet 430 is attached to the frame 420 and the other surface is attached to the flat display panel 410. The thermal conductive sheet 430 acts as a medium which transmits heat generated by the flat display panel 410 toward the frame 420 when the apparatus is operated. The thermal conductive sheet 430 is formed as at least two unit sheets which are spaced from each other at a particular interval.

As compared with the background art structure in which one thermal conductive sheet is formed on the frame, if the plurality of thermal conductive sheets 430 spaced apart from each other are formed on the frame 420 and attached to the flat display panel 410 as described above, it is possible to work with the device easily, so that an inferiority rate caused by a processing tolerance can be reduced. Also, as compared with the background art structure in which one thermal conductive sheet is formed on the frame, if a plurality of the thermal conductive sheets 430 are formed on the frame 420, a formation of an air layer between the frame 420 and the thermal conductive sheets 430 can be effectively suppressed.

In addition, in the background art structure, if the thermal conductive sheet is attached to the frame in the state where the thermal conductive sheet is not aligned with the frame, the entire thermal conductive sheet should be removed from the frame. Contrary to the background art structure, in the structure according to the present invention, although the thermal conductive sheets 430 are attached to the frame 420 in the state where one of the thermal conductive sheets 430 is not aligned with the frame 420, only the thermal conductive sheet 430 which is not aligned with the frame 420 can be removed. Therefore, the workability is made easier, and it is possible to reduce a loss of the thermal conductive sheet 430 caused by an inferior alignment state, so that manufacturing costs can be reduced.

Each edge of the thermal conductive sheets 430 attached to the frame 420 is located inside of a corresponding edge of the flat display panel 410 at a particular gap. As above, if the flat display panel 410 has margins formed on an upper edge section, a lower edge section and both side edge sections thereof, a sufficient tolerance can be obtained when the thermal conductive sheets 430 attached to the frame 420 are attached to the flat display panel 410, so that the workability can be enhanced. A detailed description on an interval between the thermal conductive sheets 430 according to a feature of the present invention as above will be described below with reference to the second embodiment.

In order to sufficiently transmit heat generated at the flat display panel 410 toward the frame, the thermal conductive sheets 430 may have a thickness of approximately 0.1 mm to 2.0 mm. The thickness of 0.1 mm of the thermal conductive sheets 430 is a minimum thickness for forming a sheet shape, and if the thickness exceeds 2 mm, a thermal conductivity is lowered so that the thermal conductive sheets 430 cannot sufficiently radiate the generated heat toward the outside of the frame 420 when the flat display apparatus 410 is operated.

The two or more thermal conductive sheets 430 are attached to the frame 420 in one of a longitudinal direction or a widthwise direction of the frame 420. The thermal conductive sheets 430 can be made of metal with a high thermal conductivity; however, it is preferable to use a thermal conductive tape or silicon and the like for convenience of the assembly process.

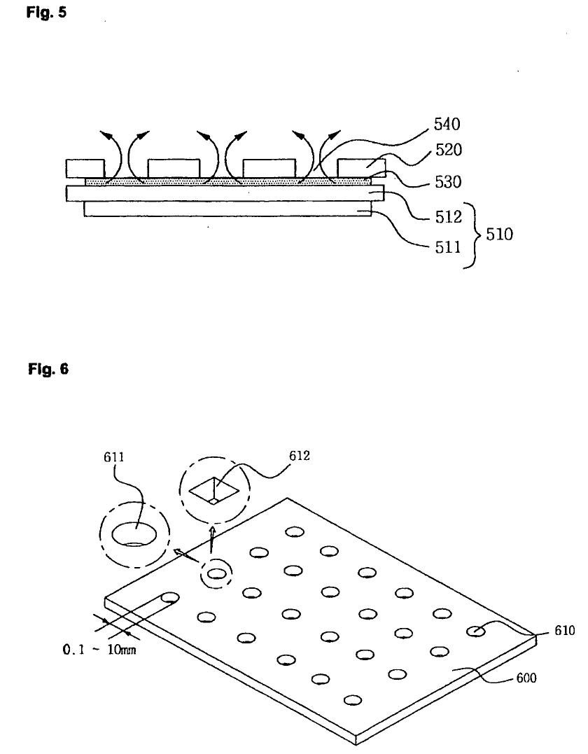

FIG. 5 is a view schematically showing another structure of the flat display apparatus according to the first embodiment of the present invention, wherein a thermal conductive sheet 530 is formed on a frame 520, and then adhered to a rear surface of a flat display panel 510. The flat display panel 510 includes a front substrate 511 of a flat display apparatus such as a PDP, an LCD and the like, and a rear substrate 512. An image is displayed on the flat display panel 510 when the flat display apparatus is operated.

The frame 520 supports the flat display panel 510 and radiates heat generated at the flat display panel 510 toward an outside when the apparatus is operated. One surface of the thermal conductive sheet 530 is attached to the frame 520 and the other is attached to the flat display panel 510. The thermal conductive sheet 530 acts as a medium which transmits heat generated at the flat display panel 510 toward the frame 520 when the apparatus is operated.

The frame 520 according to the first embodiment of the present invention has one or more holes 540 formed thereon. The holes 540 of the frame are formed on a section on which the thermal conductive sheet 530 is formed. With this structure, when the thermal conductive sheet 530 is attached to the flat display panel 510, any remaining air is exhausted through the holes 540 of the frame 520, and so a formation of air layer can be effectively suppressed.

A porous pad or a porous sheet is preferably used as the thermal conductive sheet 530 so as to enable air remaining between the flat display panel 510 and the thermal conductive sheet 530 to flow toward the frame 520 through the thermal conductive sheet 530. Since the porous pad or the porous sheet or the porous sheet makes the remaining air pass toward the frame 520 and absorbs a noise and a vibration, the porous pad or the porous sheet prevents the noise and vibration generated when the flat display panel is operated 510 from being transmitted to the frame 520. In order to absorb the noise and vibration generated in the flat display panel 510, the porous pad or the porous sheet is made of porous material with a low density and a low hardness.

The porous pad may be made by mixing urethane foam with silicon material and then applying an adhesive on front and rear surfaces of the manufactured pad, so that the porous pad or the porous sheet is obtained. Thus, due to the urethane foam, a plurality of porosities are formed in the silicon of the pad. Acryl material may be used as the adhesive applied on the front and rear surfaces of the pad. In the porous pad or the porous sheet, a content rate of the silicon is approximately 89%, a content rate of the urethane foam is approximately 10%, and a content rate of the adhesive is approximately 1%. Air remaining between the flat display panel 510 and the thermal conductive sheet 530 flows through the porosities formed by the urethane foam, and the pad having the porosities absorbs the noise and vibration transmitted to the frame 520. Also, heat which is generated when the flat display panel 510 is operated, is transmitted to the frame 520 through the silicon contained in the porous pad or the porous sheet. Because of the porosities of the porous pad or the porous sheet, the porous pad or the porous sheet absorbs external shock. Additional details concerning an embodiment of the porous pad or the porous sheet may be found in copending application Ser. No. 10/612,874, the entire contents of which are hereby incorporated by reference thereto.

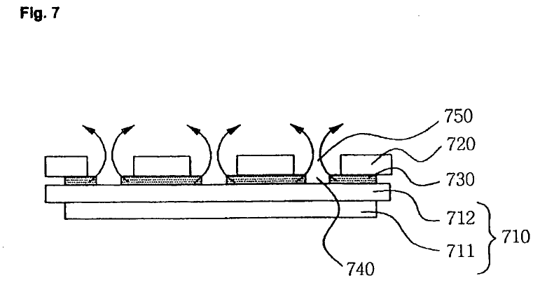

FIG. 6 is a view schematically showing a frame according to the first embodiment of the present invention.

As shown in FIG. 6, a frame 600 according to the first embodiment of the present invention has a plurality of holes 610 formed thereon. In general, when the thermal conductive sheet 530 is attached to the flat display panel 510, an air layer is not formed on only specific areas, but is formed irregularly on the entire surface. In order to suppress a formation of an irregular air layer or to remove an air layer which is already formed, the holes 610 are formed on a section of the frame 620 on which the thermal conductive sheet 530 is formed. At his time, the holes 610 are disposed regularly at regular intervals or disposed irregularly on the frame 600.

A shape of each hole 610 of the frame 600 can be any one of a circular shape 611, an elliptical shape, a rectangular shape 612 or a lozenge shape. That is, it is possible to modify a shape of the holes 610 of the frame 600 according to a convenience and a need of the manufacturer.

At this time, a size (diameter or height/width) of the hole 610 is above 0.1 mm, taking a processing tolerance into consideration, and is below 10.0 mm, taking into consideration a mechanical strength and a heat-radiating efficiency of the frame 600.

On the other hand, although air can be sufficiently exhausted through the structure of another flat display apparatus according to the first embodiment of the present invention, air can be exhausted more effectively in a structure of yet another flat display apparatus according to the first embodiment of the present invention described below.

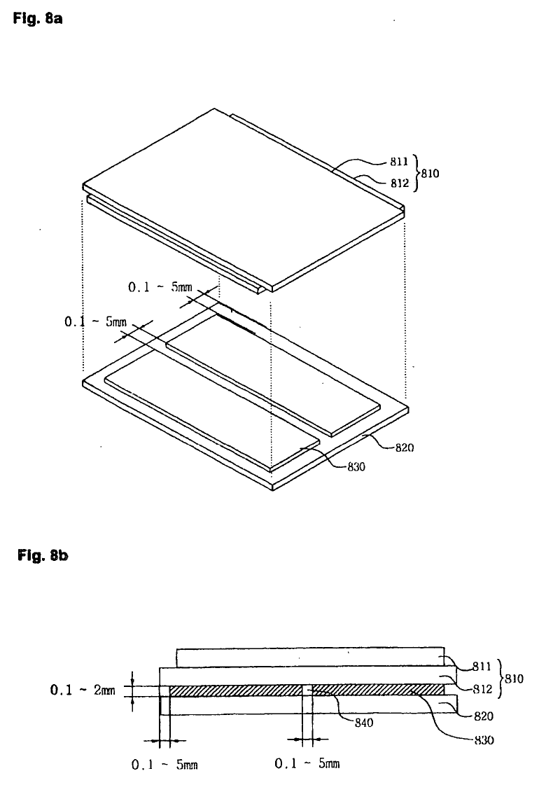

FIG. 7 is a view schematically showing another structure of the flat display apparatus according to the first embodiment of the present invention, wherein a thermal conductive sheet 730 is formed on a frame 720, and then adhered to a rear surface of a flat display panel 710.

The flat display panel 710 includes a front substrate 711 of the general flat display apparatus such as the PDP, the LCD and the like, and a rear substrate 712. An image is displayed on the flat display panel when the flat display apparatus is operated. A frame 720 supports the flat display panel 710 and radiates heat generated at the flat display panel 710 toward an outside when the apparatus is operated.

One surface of the thermal conductive sheet 730 is attached to the frame 720 and the other is attached to the flat display panel 710, so that the thermal conductive sheet 730 acts as a medium which transmits heat generated at the flat display panel 710 toward the frame 720 when the apparatus is operated.

Yet another thermal conductive sheet 730 according to the first embodiment of the present invention has one or more holes 740 formed thereon, and at least one or more holes 750 are formed on the frame 720. The holes 740 formed on the thermal conductive sheet 730 are matched with the holes 750 formed on the frame 720, respectively. By matching the holes 740 of the thermal conductive sheet 730 with the holes 750 of the frame 720, the remaining air is exhausted through the holes 740 of the thermal conductive sheet 730 and the holes 750 of the frame 720 matched with the holes 740 of the thermal conductive sheet 730 when the thermal conductive sheet 730 is attached to the flat display panel 710.

Also, thermal conductive sheet 730 is made of the porous material so that air can be effectively exhausted through the thermal conductive sheet 730 itself and the holes 740 of the thermal conductive sheet 730.

A size (diameter or width/height) of each hole 740 of the thermal conductive sheet 730 is 0.1 mm to 5.0 mm. The minimum size of the hole 740 is 0.1 mm, taking into consideration the processing tolerance, and 5.0 mm is a maximum size of the hole 740, taking into consideration that the thermal conductive sheet 730 at a portion on which the hole 740 is formed is decreased. A size (diameter or width×height) of each hole 750 of the frame is 0.1 mm or more, taking into consideration the processing tolerance, and is 10.0 mm or less, taking into consideration a mechanical strength and a heat radiating-efficiency of the frame 720.

Also, air is exhausted smoothly by matching the holes 750 of the frame 720 with the holes 740 of the thermal conductive sheet 730. The number of holes 750 of the frame 720 is preferably the same as the number of holes 740 of the thermal conductive sheet 730, and so an efficiency of the frame 720 can be increased.

A support bracket (not shown) and a mount (not shown) may be provided on a rear surface of the frame 720 for supporting and fixing the flat display apparatus. A formation of air layer can be suppressed by forming the holes 750 at a section of the frame 720 adjacent to a section on which it is difficult to form the hole.

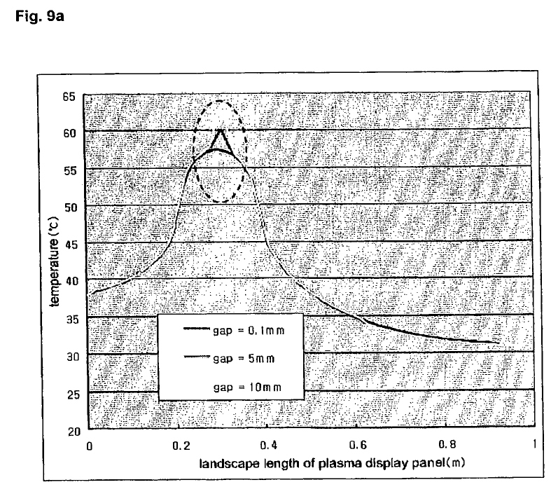

Hereinafter, a second embodiment is described with referenced to accompanying drawings. FIG. 8a and FIG. 8b are views for illustrating a structure of the flat display apparatus according to the second embodiment of the present invention. FIG. 8a is a view schematically showing that a thermal conductive sheet 830 formed on a frame 820 is adhered to a flat display panel 810, and FIG. 8b is a side view showing the thermal conductive sheet 830 placed between the flat display panel 810 and the frame 820.

Referring to FIG. 8a and FIG. 8b, a thermal conductive sheet 830 of the flat display apparatus according to the second embodiment of the present invention is formed on a frame 820, and then adhered to a rear surface of a flat display panel 810.

The flat display panel 810 includes a front substrate 811 of the general flat display apparatus such as a PDP, an LCD and the like, and a rear substrate 812. An image is displayed on the flat display panel 810 when the flat display apparatus is operated. The frame 820 supports the flat display panel 810 and radiates heat generated at the flat display panel 810 toward an outside when the apparatus is operated.

One surface of the thermal conductive sheet 830 is attached to the frame 820 and the other surface is attached to the flat display panel 810 The thermal conductive sheet 830 acts as a medium which transmits heat generated by the flat display panel 810 toward the frame 820 when the apparatus is operated. The thermal conductive sheet 830 contains a plurality of sheets, which are spaced apart from each other at certain intervals.

When two or more thermal conductive sheets 830 are formed at certain intervals, the workability is enhanced, a formation of the air layer is suppressed and a manufacturing cost is reduced. The description is omitted since the description thereof has been set forth above regarding the first embodiment of the present invention.

As shown in FIG. 8b, since the thermal conductive sheet 830 is not formed on a space section 840 between the thermal conductive sheets 830, if the flat display apparatus is operated for long time, heat generated at the flat display panel 810 cannot be transmitted sufficiently toward the frame 820. In particular, in proportion to a width of the space section 840, a temperature gradient is generated excessively on the flat display panel 810 matched with the space section 840 on which the thermal conductive sheet is not formed. Due to the temperature gradient, the misdischarge is generated in the flat display panel 810 when the flat display apparatus is operated.

That is, when a width of the space section 840 is narrow, there are drawbacks that the workability becomes lower and an occurrence ratio of an air layer is increased since it is difficult to exhaust air when the thermal conductive sheets 830 are adhered to the flat display panel 810. On the other hand, when a width of the space section 840 is wide, the misdischarge is induced due to the temperature gradient of the flat display panel 810.

In the second embodiment of the present invention, it is desirable that a width of the space section 840 between the thermal conductive sheets 830 is 0.1 mm to 5.0 mm. A minimum interval of 0.1 mm takes into consideration the processing tolerance, and a maximum interval of 5.0 mm is an interval at which the misdischarge caused by the temperature gradient of the flat display panel 810 can be prevented.

Also, in the second embodiment of the present invention, the thermal conductive sheets 830 are formed such that an interval between an edge of the each thermal conductive sheet 830 and an edge of the flat display panel 810 is 0.1 mm to 5.0 mm. A minimum interval of 0.1 mm takes into consideration the processing tolerance, and a maximum interval of 5.0 mm is an interval at which the misdischarge caused by the temperature gradient of the flat display panel 810 can be prevented.

Preferably, an interval between an edge of the each thermal conductive sheet 830 and an edge of the display area of the flat display panel on which an image display is displayed when the flat display apparatus is operated is preferably 5 mm or less. Thus, a manufacturing cost of the thermal conductive sheet 830 can be saved.

Also, a thickness of the thermal conductive sheet 830 is preferably 0.1 mm to 2.0 mm, and the misdischarge caused by the temperature gradient is not generated in the flat display panel 890 when the space section 840 between the thermal conductive sheets 830 is 5.0 mm or less. That is, relating to a width of the space section 840 between the thermal conductive sheets 830, a thickness of the thermal conductive sheet 830 acts as a factor which influences the temperature gradient. A minimum thickness of 0.1 mm takes into consideration the processing tolerance, and 5.0 mm is a maximum thickness at which an acceptable temperature gradient is generated. A thermal conductivity of the entire thermal conductive sheet 830 with a thickness of 2 mm is significantly reduced, thus the temperature gradient is generated if a width of the space section 840 between the thermal conductive sheets 830 is 5.0 mm or less.

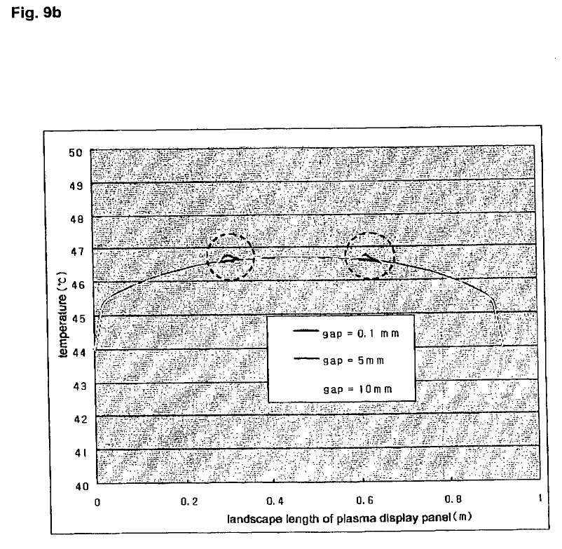

FIG. 9a and FIG. 9b are graphs for illustrating the thermal characteristic of the flat display panel according to the second embodiment of the present invention. The x axis in FIG. 9a indicates each position in a widthwise direction of the flat display panel, and the y axis indicates a temperature measured at each position of the flat display panel. Two thermal conductive sheets 830 are formed on the frame 820, and a certain interval between the two thermal conductive sheets 830 is formed at a section from which the zero point is spaced apart at 0.35 m. The curves indicate changes of the temperature at the position at which the interval between the thermal conductive sheets is 0.1 mm, 5.0 mm and 10.0 mm, respectively.

The x axis in FIG. 9b indicates each position in a widthwise direction of the flat display panel, and the y axis indicates a temperature measured at each position of the flat display panel. Three thermal conductive sheets 830 are formed on the frame, and certain intervals between two thermal conductive sheets 830 are formed at a section from which the zero point is spaced apart at 0.35 m and 0.65 m. The curves indicate changes of the temperature at the position at which the interval between the thermal conductive sheets is 0.1 mm, 5.0 mm and 10.0 mm, respectively.

As shown in FIG. 9a and FIG. 9b, in proportion to the interval between the thermal conductive sheets, a temperature at a section of the flat display panel corresponding to the interval between the thermal conductive sheets is increased. When the interval between the thermal conductive sheets is 5.0 mm or less, a misdischarge caused by the temperature gradient is not generated.

As described above, in one embodiment of the present invention, the thermal conductive sheet is placed between the flat display panel and the frame, the thermal conductive sheet is divided into two or more sheets, and the interval is formed between the thermal conductive sheets. With this, a process for forming the thermal conductive sheet is easily performed, a formation of air layer can be suppressed and a manufacturing cost can be lowered.

Considering that the air layer is widely generated when the interval between the thermal conductive sheets is narrow and a uniformity of temperature of the flat display panel deteriorates when the interval between the thermal conductive sheets is wide, it is desirable that the interval between the thermal conductive sheets is 0.1 mm to 5.0 mm. In the above limitation of the interval, it is preferable that the thickness of the thermal conductive sheets is 0.1 to 2.0 mm, and a material of the thermal conductive sheets and a direction in which the thermal conductive sheet is formed are not limited.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A flat display apparatus, comprising
a display panel;
a frame provided at a rear surface of the display panel; and
at least two thermal conductive sheets located between the display panel and the frame, the thermal conductive sheets being side-by-side and spaced apart from each other.

2. The flat display apparatus as claimed in claim 1, wherein the thermal conductive sheets have a smaller size than a size of the display panel, whereby edges of the thermal conductive sheets are spaced inwardly from an edge of the display panel.

3. The flat display apparatus as claimed in claim 1, wherein an interval between the thermal conductive sheets is 0.1 mm to 5.0 mm.

4. The flat display apparatus as claimed in claim 1, wherein the thermal conductive sheets have a thickness of 0.1 mm to 2.0 mm.

5. The flat display apparatus as claimed in claim 1, wherein the thermal conductive sheets are arranged in the direction which is a longitudinal direction or a widthwise direction of the frame.

6. The flat display apparatus as claimed in claim 1, wherein the thermal conductive sheets are porous sheets.

7. The flat display apparatus as claimed in claim 6, wherein the porous sheets contain a foaming agent.

8. The flat display apparatus as claimed in claim 7, wherein the foaming agent comprises urethane foam.

9. The flat display apparatus as claimed in claim 6, wherein the porous sheets contain silicon material.

10. The flat display apparatus as claimed in claim 1, wherein the frame has one or more holes therein.

11. The flat display apparatus as claimed in claim 1, wherein the thermal conductive sheets and the frame each have one or more holes located therein.

12. The flat display apparatus as claimed in claim 11, wherein the holes formed in the thermal conductive sheets are aligned with the holes formed in the frame.

13. The flat display apparatus as claimed in claim 1, wherein the display panel is a plasma display panel.

14. A flat display apparatus, comprising
a display panel;
a frame provided at a rear surface of the display panel; and
at least two thermal conductive porous sheets located between the display panel and the frame, the thermal conductive porous sheets being side-by-side and spaced apart from each other,
wherein an interval between the thermal conductive porous sheets is 0.1 mm to 5.0 mm.

15. The flat display apparatus as claimed in claim 14, wherein the porous sheets contain a foaming agent.

16. The flat display apparatus as claimed in claim 15, wherein the foaming agent comprises urethane foam.

17. The flat display apparatus as claimed in claim 14, wherein the porous sheets contain silicon material.

18. The flat display apparatus as claimed in claim 14, wherein the frame has one or more holes therein.

19. The flat display apparatus as claimed in claim 14, wherein the porous sheets and the frame each have one or more holes located therein.

20. The flat display apparatus as claimed in claim 19, wherein the holes formed in the porous sheets are aligned with the holes formed in the frame.

21. The flat display apparatus as claimed in claim 14, wherein the display panel is a plasma display panel.

22. A flat display apparatus, comprising
a display panel;
a frame provided at a rear surface of the display panel, a first region of the frame having one or more holes therein; and
a thermal conductive sheet located between the display panel and the frame, wherein the thermal conductive sheet is located at the first region of the frame.

23. The flat display apparatus as claimed in claim 22, wherein the thermal conductive sheet is a porous sheet containing a foam agent.

24. The flat display apparatus as claimed in claim 22, wherein the holes are disposed in an orderly pattern in the frame.

25. The flat display apparatus as claimed in claim 22, wherein the holes are disposed in a random pattern in the frame.

26. The flat display apparatus as claimed in claim 22, wherein each hole formed in the frame has a size of 0.1 mm to 10.0 mm.

27. The flat display apparatus as claimed in claim 22, wherein the thermal conductive sheet has one or more holes formed therein.

28. The flat display apparatus as claimed in claim 27, wherein each hole formed in the thermal conductive sheet has a size of 0.1 mm to 5.0 mm.

29. The flat display apparatus as claimed in claim 27, wherein the holes formed in the thermal conductive sheet are aligned with the holes formed in the frame.

30. The flat display apparatus as claimed in claim 22, wherein the display panel is a plasma display panel.
